(19) United States
(12) Patent Application Publication
(10) Pub. No.: US 2024/0229676 A1
(43) Pub. Date: Jul. 11, 2024

(54) PRESSURE CONTROL VALVE FOR TURBOEXPANDER OVERSPEED PROTECTION

(71) Applicant: Sapphire Technologies, Inc., Cerritos, CA (US)

(72) Inventor: Gary Provenzano, San Diego, CA (US)

(21) Appl. No.: 18/153,202

(22) Filed: Jan. 11, 2023

(51) Int. Cl. F01D 21/14; F01D 15/10; F01D 21/02

(52) U.S. Cl. CPC F01D 21/14; F01D 15/10; F01D 21/02; F05D 2220/7642; F05D 2220/768; F05D 2260/903; F05D 2270/021; F05D 2270/09; F05D 2270/3015

(57) ABSTRACT

An electric generator includes a turbine wheel configured to receive process gas and rotate in response to expansion of the process gas flowing into an inlet of the turbine wheel. A rotor is coupled to the turbine wheel and can rotate with the turbine wheel in a stator. The electric generator generates a current upon rotation of the rotor within the stator. A power electronics system is electrically connected to an electrical output of the electric generator and receives alternating current from the electric generator. A fast stop valve resides proximate and upstream from an inlet conduit of the electric generator. The fast stop valve can quickly shut upon detection of a fault condition at the power electronics or the grid, to prevent an overspeed of the rotor.

### BACKGROUND

Natural gas is one of the principal sources of energy for many of our day-to-day needs and activities. Natural gas is an attractive fossil fuel for its abundance and relative cleanliness. Hydrogen is a rapidly expanding global energy storage market. Hydrogen is used in many manufacturing processes from petroleum refining to food processing. Hydrogen is also used as a fuel source for gas turbines and in a broad range of fuels cells to generate electricity in industrial and consumer transportation sectors.

The efficient and effective movement of such gases from producing regions to consumption regions requires an extensive and elaborate transportation system. Natural gas that is transported through pipelines travels at high pressure in the pipeline.

### BRIEF DESCRIPTION OF THE DRAWINGS

FIG. 1 is a schematic diagram of an electric power generation system coupled to a power grid in accordance with embodiments of the present disclosure.

FIG. 2 is a schematic diagram of an example turboexpander system that includes a flow control system in accordance with embodiments of the present disclosure.

FIG. 3 is a schematic diagram of an example electric power generator system that includes a fast stop valve in accordance with embodiments of the present disclosure.

FIG. 4A is a graphical representation of a rotor speed as a function of time when using a fast stop valve to stop gas flow into an inlet conduit of a turboexpander in accordance with embodiments of the present disclosure.

FIG. 4B is a graphical representation of a rotor speed as a function of time when using a fast stop valve to stop gas flow into an inlet conduit of a turboexpander and a brake resistor in accordance with embodiments of the present disclosure.

FIG. 5 is a process flow diagram for controlling a rotational speed of a rotor during a shutdown sequence in accordance with embodiments of the present disclosure.

Like reference symbols in the various drawings indicate like elements. Drawings not to scale.

### DETAILED DESCRIPTION

Natural gas, hydrogen, and other process gases are pressurized to facilitate efficient transportation in pipelines that are sometimes many miles long. The pipelines, for example, transport gasses from production sites (e.g., wells) to processing facilities and from processing facilities to local distribution networks, such as regional, city or district networks or on site industrial plants networks. To deliver the gas safely through local distribution networks and for use, the process gas is depressurized to lower levels (often using pressure regulators). The pressure is stepped down at pressure letdown (PLD) stations for delivery to industrial, commercial, and residential end users. The PLD stations use regulating valves to achieve the required pressure drop, but also waste significant amounts of energy in the process. Additional regulating valves can be used at other locations for pressure control, such as in the pipelines between the production and processing facilities, within the sub-processes of the processing facilities, and within the end user's processes and piping. A turboexpander generator can be installed in parallel to the regulating valve to recover the wasted energy from pressure reduction and produce electrical power. The electrical power can be directed to a power grid or elsewhere. Along the same lines, a turboexpander generator can be installed at a gas storage facility upstream of one or more storage tanks to recover high pressure gasses dispensed from a tanker truck, through the turboexpander generator, to the storage tanks. The turboexpander generator is relevant in other applications, such as in a hydrogen liquefaction process where gaseous hydrogen that has been cooled and pressurized is expanded to a liquid state. The expansion can be performed through a turboexpander generator to recover the wasted energy from the expansion and produce electrical power. As above, the electrical power can be directed to a power grid or elsewhere, such as used to power compressors or other components of the liquefaction process. In each instance, by recovering lost energy from natural gas and hydrogen pressure letdown applications, the turboexpander can generate electricity while also reducing CO2 emissions, increasing overall plant efficiency, offsetting electrical costs, and generating additional revenue.

The power grid that the turboexpander can supply power to (and draw power from) can be a national or regional power grid, a local power grid for a city or district, or a small grid, local grid, or microgrid, such as an on-site grid that supplies power to a building, campus, industrial manufacturing or processing plant, or neighborhood.

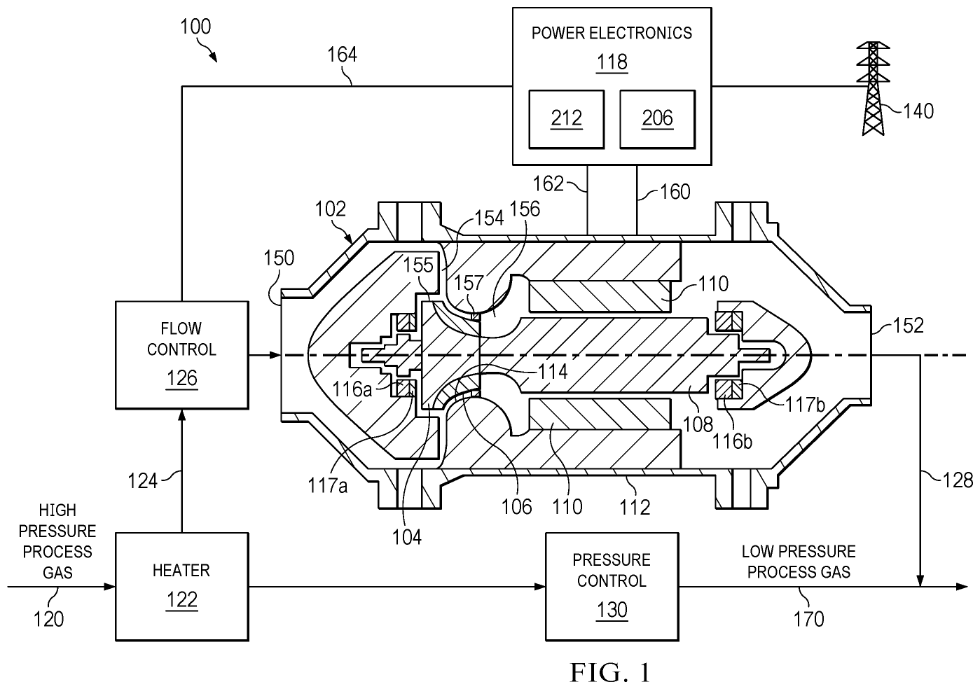

FIG. 1 is a schematic diagram of an electric power generation system 100 coupled to a power grid 140 in accordance with embodiments of the present disclosure. The electric power generation system 100 can be added at a PLD station to capture energy from gas expansion from the PLD process, or in any of the other applications described above. The electric power generation system 100 includes a turboexpander 102 in parallel with a pressure control valve 130. The turboexpander 102 is arranged axially so that the turboexpander 102 can be mounted in-line with a pipe. The turboexpander 102 acts as an electric generator by generating electrical energy from rotational kinetic energy derived from expansion of a gas through a turbine wheel 104. For example, rotation of the turbine wheel 104 can be used to rotate a rotor 108 within a stator 110, which then generates electrical energy.

The turboexpander 102 includes a high-performance, high-speed permanent magnet generator with an integrated radial in-flow expansion turbine wheel 104 and low loss active magnetic bearings (AMBs) 116a,b. The rotor assembly consists of the permanent magnet section with the turbine wheel 104 mounted directly to the rotor hub. The rotor 108 is levitated by the magnetic bearing system creating a frictionless (or near frictionless) interface between dynamic and static components. The AMBs 116a,b facilitate a lossless (or near lossless) rotation of the rotor 108.

The turboexpander 102 includes a high-performance, high-speed permanent magnet generator with an integrated radial in-flow expansion turbine wheel 104 and low loss active magnetic bearings (AMBs) 116a,b. The rotor assembly consists of the permanent magnet section with the turbine wheel 104 mounted directly to the rotor hub. The rotor 108 is levitated by the magnetic bearing system creating a frictionless (or near frictionless) interface between dynamic and static components. The AMBs 116a,b facilitate a lossless (or near lossless) rotation of the rotor 108.

The turboexpander 102 is designed to have the process gas flow through the system, which cools the generator section and eliminates the need for auxiliary cooling equipment. The power electronics 118 for turboexpander combines a Variable Speed Drive (VSD) 206 and Magnetic Bearing Controller (MBC) 212 into one cabinet, in some implementations. The VSD allows for a consistent and clean delivery of generated power from the turboexpander 102 to a power grid 140. The VSD 206 regulates the frequency and amplitude of the generated current to match the local grid. After expansion, the gas exits the turboexpander 102 along the same axial path for downstream processes.

The turboexpander 102 includes a flow-through configuration. The flow-through configuration permits process gas to flow from an inlet side of the turboexpander 102 to an outlet side of the turboexpander 102. The gas flows into a radial gas inlet 154 to a turbine wheel 104 and an axial gas outlet 156 from the turbine wheel 104. The gas then flow through the generator and out of the outlet 156, where the gas rejoins the gas pipeline 170. Generally, high pressure process gas 120 is directed to flow into the turboexpander 102 through a flow control system 126. The flow control system 126 can include one or more of a flow or mass control valve, a fast stop valve, a slam valve, an isolation valve, and an emergency shut off valve. In embodiments, any number of valves can be positioned upstream of inlet conduit 150 for various purposes, including flow or pressure control, emergency shutdown, and fluid isolation. The term “flow control system 126” is used herein to refer to one or more valves for controlling the flow of gas into the inlet conduit 150.

In embodiments, the turboexpander housing 112 is hermetically sealed.

The high pressure process gas 120 is expanded by flowing through the turbine wheel 104, resulting in a pressure letdown of the process gas. Lower pressure process gas 128 exits the turboexpander. The expansion of the high pressure process gas 120 through the turbine wheel 104 causes the turbine wheel 104 to rotate, which causes the rotor 108 to rotate. The rotation of the rotor 108 within the stator 110 generates electrical energy. The turboexpander 102 achieves the desired pressure letdown and captures the energy from the pressure letdown to generate electricity. A pressure control valve 130, such as a conventional pressure regulator, can be installed in parallel to the turboexpander 102. The pressure control valve 130 can be used to control the pressure of the high pressure process gas 120 that flows through the turboexpander. Any excess high pressure process gas that is not directed into the turboexpander can be directed through the pressure control valve 130.

In some embodiments, a heater 122 can heat the high pressure process gas 120 prior to flowing the gas into the turboexpander 102. For example, if the expansion of the gas through the turbine wheel 104 lowers the temperature of the process gas to a point where moisture in the gas freezes at the turbine wheel or other downstream locations in the pipeline, the pressurized process gas 120 can be heated by heater 122. Heated high pressure process gas 124 can then be directed into the turboexpander 102. The heating of the process gas can prevent freezing moisture as the gas expands and its temperature drops.

The turboexpander 102 includes a turbine wheel 104. The turbine wheel 104 is shown as a radial inflow turbine wheel, though other configurations are within the scope of this disclosure, such as axial flow turbine wheels. In this example, heated high pressure process gas 124 is received from an inlet conduit 150 of the housing 112 enters a radially oriented inlet 154 of the turbine wheel 104. In certain embodiments, the fluid flows through an inlet conduit 150 and is diverted by a flow diverter to a radial inlet 154 that directs the flow into the radial inflow of the turbine wheel 104. After expanding, the lower pressure process gas exits the turbine wheel 104 from an axially oriented outlet 156 to outlet conduit 152 of the housing 112.

The turbine wheel 104 can be directly affixed to the rotor 108, or to an intermediate common shaft, for example, by fasteners, rigid drive shaft, welding, or other manner. For example, the turbine wheel 104 may be received at an end of the rotor 108, and held to the rotor 108 with a shaft. The shaft threads into the rotor 108 at one end, and at the other, captures the turbine wheel 104 between the end of rotor 108 and a nut threadingly received on the shaft. The turbine wheel 104 and rotor 108 can be coupled without a gearbox and rotate at the same speed. In other instances, the turbine wheel 104 can be indirectly coupled to the rotor 108, for example, by a gear train, clutch mechanism, or other manner.

The turbine wheel 104 includes a plurality of turbine wheel blades 106 extending outwardly from a hub and that react with the expanding process gas to cause the turbine wheel 104 to rotate. FIG. 1 shows an unshrouded turbine wheel, in which each of the turbine blades 106 has an exposed, generally radially oriented blade tip extending between the radial inlet 154 and axial outlet 156. As discussed in more detail below, the blade tips substantially seal against a shroud 114 on the interior of the housing 112. In certain instances, the turbine wheel 104 is a shrouded turbine wheel.

In configurations with an un-shrouded turbine wheel 104, the housing 112 includes an inwardly oriented shroud 114 that resides closely adjacent to, and at most times during operation, out of contact with the turbine wheel blades 106. The close proximity of the turbine wheel blades 106 and shroud 114 substantially seals against passage of process gas therebetween, as the process gas flows through the turbine wheel 104. Although some amount of the process gas may leak or pass between the turbine wheel blades 106 and the shroud 114, the leakage is insubstantial in the operation of the turbine wheel 104. In certain instances, the leakage can be commensurate with other similar unshrouded-turbine/shroud-surface interfaces, using conventional tolerances between the turbine wheel blades 106 and the shroud 114. The amount of leakage that is considered acceptable leakage may be predetermined. The operational parameters of the turbine generator may be optimized to reduce the leakage. In embodiments, the housing 112 is hermetically sealed to prevent process gases from escaping the radial inlet 154 of the turbine wheel 104.

The shroud 114 may reside at a specified distance away from the turbine wheel blades 106, and is maintained at a distance away from the turbine wheel blades 106 during operation of the turboexpander 102 by using magnetic positioning devices, including active magnetic bearings and position sensors.

Bearings 116a and 116b are arranged to rotatably support the rotor 108 and turbine wheel 104 relative to the stator 110 and the shroud 114. The turbine wheel 104 is supported in a cantilevered manner by the bearings 116a and 116b. In embodiments, the turbine wheel 104 may be supported in a non-cantilevered manner and bearings 116a and 116b may be located on the outlet side of turbine wheel 104. In certain instances, one or more of the bearings 116a or 116b can include ball bearings, needle bearings, magnetic bearings, foil bearings, journal bearings, or others.

Bearings 116a and 116b may be a combination radial and thrust bearing, supporting the rotor 108 in radial and axial directions. Other configurations could be utilized. The bearings 116a and 116b need not be the same types of bearings.

In the embodiments in which the bearings 116a and 116b are magnetic bearings, a magnetic bearing controller (MBC) 212 is used to control the magnetic bearings 116a and 116b. Position sensors 117a, 117b can be used to detect the position or changes in the position of the turbine wheel 104 and/or rotor 108 relative to the housing 112 or other reference point (such as a predetermined value). Position sensors 117a, 117b can detect axial and/or radial displacement. The magnetic bearing 116a and/or 116b can respond to the information from the positions sensors 117a, 117b and adjust for the detected displacement, if necessary. The MBC 212 may receive information from the position sensor(s) 117a, 117b and process that information to provide control signals to the magnetic bearings 116a, 116b. MBC 212 can communicate with the various components of the turboexpander 102 across a communications channel 162.

The use of magnetic bearings 116a, 116b and position sensors 117a, 117b to maintain and/or adjust the position of the turbine wheel blades 106 such that the turbine wheel blades 106 stay in close proximity to the shroud 114 permits the turboexpander 102 to operate without the need for seals (e.g., without the need for dynamic seals). The use of the active magnetic bearings 116a,b in the turboexpander 102 eliminates physical contact between rotating and stationary components, as well as eliminate lubrication, lubrication systems, and seals.

The turboexpander 102 may include one or more backup bearings. For example, at start-up and shut-down or in the event of a power outage that affects the operation of the magnetic bearings 116a and 116b, bearings may be used to rotatably support the turbine wheel 104 during that period of time. The backup bearings and may include ball bearings, needle bearings, journal bearings, or the like.

As mentioned previously, the turboexpander 102 is configured to generate electricity in response to the rotation of the rotor 108. In certain instances, the rotor 108 can include one or more permanent magnets. The stator 110 includes a plurality of conductive coils. Electrical current is generated by the rotation of the magnet within the coils of the stator 110. The rotor 108 and stator 110 can be configured as a synchronous, permanent magnet, multiphase alternating current (AC) generator. The electrical output 160 can be a three-phase output, for example. In certain instances, stator 110 may include a plurality of coils (e.g., three or six coils for a three-phase AC output). When the rotor 108 is rotated, a voltage is induced in the stator coil. At any instant, the magnitude of the voltage induced in coils is proportional to the rate at which the magnetic field encircled by the coil is changing with time (i.e., the rate at which the magnetic field is passing the two sides of the coil). In instances where the rotor 108 is coupled to rotate at the same speed as the turbine wheel 104, the turboexpander 102 is configured to generate electricity at that speed. Such a turboexpander 102 is what is referred to as a “high speed” turbine generator. For example, in embodiments, the turboexpander 102 can produce up to 280 kW at a continuous speed of 30,000 rpm. In embodiments, the turboexpander can produce on the order of 350 kW at higher rotational speeds (e.g., on the order of 35,000 rpm).

In some embodiments, the design of the turbine wheel 104, rotor 108, and/or stator 110 can be based on a desired parameter of the output gas from the turboexpander 102. For example, the design of the rotor and stator can be based on a desired temperature of the gas 128.

The turboexpander 102 can be coupled to a power electronics 118. Power electronics 118 can include a variable speed drive (VSD) 206 (or variable frequency drive) and the magnetic bearing controller (MBC) 212 (discussed above).

The electrical output 160 of the turboexpander 102 is connected to the VSD 206, which can be programmed to specific power requirements. The VSD 206 can include an insulated-gate bipolar transistor (IGBT) rectifier 208 to convert the variable frequency, high voltage output from the turboexpander 102 to a direct current (DC). The rectifier 208 can be a three-phase rectifier for three-phase AC input current. An inverter 210 then converts the DC from the rectifier AC for supplying to the power grid 140. The inverter 210 can convert the DC to 380 VAC-480 VAC at 50 to 60 Hz for delivery to the power grid. The specific output of the VSD 206 depends on the power grid and application. Other conversion values are within the scope of this disclosure. The VSD 206 matches its output to the power grid 140 by sampling the grid voltage and frequency, and then changing the output voltage and frequency of the inverter 210 to match the sampled power grid voltage and frequency.

The turboexpander 102 is also connected to the MBC 212 in the power electronics 118. The MBC 212 constantly monitors position, current, temperature, and other parameters to ensure that the turboexpander 102 and the active magnetic bearings 116a and 116b are operating as desired. For example, the MBC 212 is coupled to position sensors 117a, 117b to monitor radial and axial position of the turbine wheel 104 and the rotor 108. The MBC 212 can control the magnetic bearings 116a, 116b to selectively change the stiffness and damping characteristics of the magnetic bearings 116a, 116b as a function of spin speed. The turboexpander 102 can include sensors that monitor rotor speed that are connected to the MBC 212. The MBC 212, therefore, can monitor rotor speed. The MBC 212 can also control synchronous cancellation, including automatic balancing control, adaptive vibration control, adaptive vibration rejection, and unbalance force rejection control.

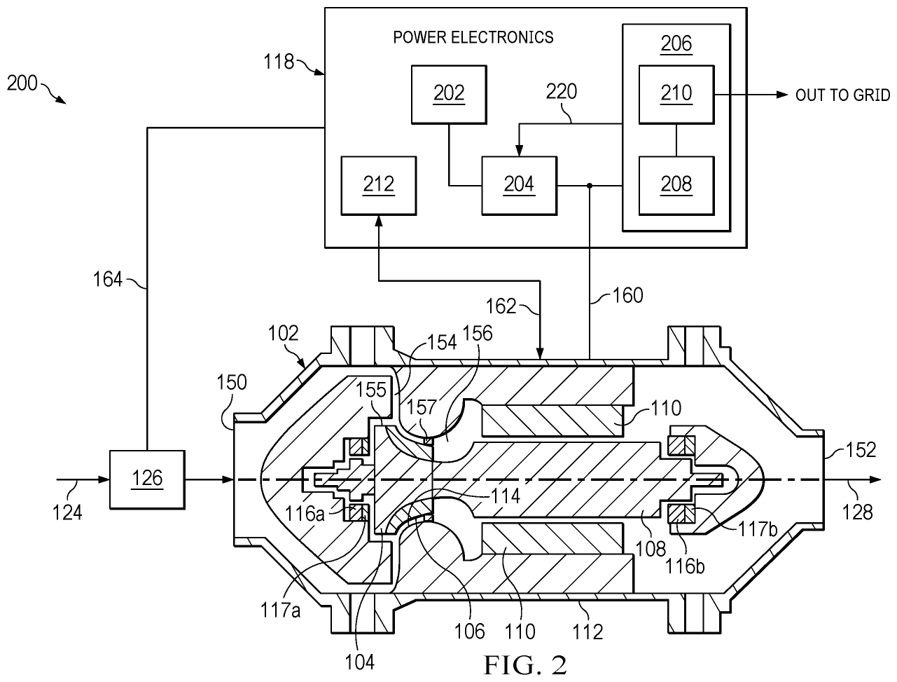

FIG. 2 is a schematic diagram of an example turboexpander system 200 that includes a flow control system 126 in accordance with embodiments of the present disclosure. Turboexpander system 200 includes a turboexpander 102 and a power electronics 118. The turboexpander 102 receives a heated high pressure process gas 124, which causes a turbine wheel 104 to rotate. The rotation of the turbine wheel 104 rotates a rotor 108 that supports a plurality of permanent magnets. The rotation of the permanent magnets on the rotor 108 induces a current through coils or windings on stator 110.

The electric generator system acts as a brake on the rotor 108. This braking torque converts the shaft power, created by the process gas flow, to electrical power that can be put on an electrical grid, for example. In the case of a grid failure, inverter failure, power electronics failure, or other fault condition, braking torque is lost and the rotor 108 may spin up towards an undesirable overspeed. If there is a fault condition causing the power output to be disconnected from the grid or other electrical load, the inertia of rotor 108 will cause the speed of the rotor 108 to increase due to continued gas flow. To prevent the rotor 108 from reaching a maximum design overspeed condition, the gas flow though the turboexpander must be isolated fast enough or the power output must be absorbed or both.

This disclosure describes incorporating a fast stop valve next to the inlet conduit 150 of the turboexpander 102. The fast stop valve is designed to close a valve quickly upon detection of a fault condition. The fast stop valve can isolate the flow of gas into the inlet conduit 150, which will prevent further increase of speed and protect the rotor from an overspeed condition. The fast stop valve can be controlled using a wired or wireless signal. The fast stop valve can be positioned close to the turboexpander 102 to minimize the volume of gas in the piping that will flow though the turboexpander once the valve is closed.

If the valve can close before the rotor reaches the maximum overspeed design limit, with some safety margin, then the system is protected. In some embodiments, the fast stop valve can obviate the need for artificial loads, such as a brake resistor, or reduce the size of the brake resistor. In addition, embodiments can also include an isolation valve upstream from the inlet conduit 150. Isolation valves can be collocated with the fast stop valve or can be upstream of the fast stop valve.

If the valve does not close before the rotor reaches the maximum overspeed design limit, then an artificial load (e.g., a brake resistor assembly) can be used to absorb the amount of power to prevent the rotor from exceeding the maximum overspeed design limit, with some safety margin. This load is proportional to the rotor's inertia, as well as the power. Therefore, some embodiments use both a fast stop valve and a brake resistor to ensure that the rotor 108 does not exceed maximum overspeed design limits.

To prevent overspeed, the power can be diverted to a brake resistor assembly 202 that can temporarily absorb the electricity until the process gas flow is reduced or removed (e.g., by flow control system 126) or until the fault condition is resolved. Flow control system 126 can include a one or a combination of a flow control valve or a mass control valve or an emergency shutoff valve. Flow control system 126 can be controlled by power electronics 118 or other electrical, mechanical, or electromagnetic signal. For example, a fault condition can signal the flow control system 126 to close or partially close, thereby removing or restricting gas supply to the turboexpander 102. Restricting or removing gas flow to the turboexpander slows the rotation of the turbine wheel and consequently, slows the rotor. In the example shown in FIGS. 1 and 2, a signal channel 164 from the power electronics 118 can be used to open and/or close the flow control system 126. In some embodiments, the signal channel 164 can carry a shutoff signal to fast stop valve to quickly shut off gas flow into the turbine 104. The shutoff signal can cause the flow control system 126 to close a valve to prevent gas from flowing into the turboexpander 102 during fault conditions to prevent the turboexpander from overspeed. The signal channel 164 can be a wired or wireless signal.

A fault condition can include a grid failure, VSD failure, inverter failure, or other type of electrical fault condition. A fault condition can include any condition that removes or reduces the braking torque on the rotor 108. Fault condition can be determined by a master controller 320 that monitors electricity or power draw, such as by monitoring circuit breakers. The master controller 320 can cause the fast stop valve to close when it detects the fault condition. In embodiments, the fast stop valve can be directly connected (electrically) to a circuit breaker or other electrical connection so that the fast stop valve can immediately close when a fault condition occurs.

In some embodiments, a brake resistor assembly 202 is electrically connected to the electrical output 160 of the turboexpander 102 (e.g., the output of the generator). The brake resistor assembly 202 can have a tuned impedance to allow an efficient transfer of power from the turboexpander 102 to the brake resistor assembly 202. The brake resistor assembly 202 can include one or more circuit elements that are selected so the brake resistor impedance matches the impedance of the turboexpander. The tuning of the brake resistor can be determined based on the speed that the fast stop valve takes to close in the event of a fault condition. The faster the response time of the fast stop valve, the smaller the brake resistor design, because the brake resistor will not need to absorb power output from the turboexpander generator for long.

In embodiments, a contactor 204 can connect the output current of the turboexpander 102 to the brake resistor assembly 202 when there is a fault condition at the VSD 206 or the power grid 140. The contactor 204 is an electrically controlled switch for switching in an electrical power circuit. The contactor 204 can accommodate the three-phase current output from the generator to direct the current to the brake resistor assembly 202.

In some embodiments, the contactor 204 is connected directly to the (three-phase) electrical output 160 of the turboexpander 102. In some embodiments, the brake resistor assembly 202 and/or the contactor 204 are not part of the power electronics, but are connected to the electrical output 160 of the turboexpander 102 outside of the power electronics 118.

The VSD 206 can provide an energizing signal 220 to the coil of the contactor 204 to cause the contactor 204 to connect the electrical output 160 of the turboexpander to the brake resistor assembly 202. Depending on the implementation choice, the contactor 204 can be a normally closed (NC) contactor or a normally open (NO) contactor.

For example, in an example implementation using a NO contactor, during normal operating conditions, the electrical output 160 of the turboexpander 102 is connected to the VSD 206 and supplies three-phase AC current to the VSD 206. In a fault condition, the VSD can energize the contactor to connect the contactor to the electrical output 160 of the turboexpander 102. In some implementations, the energizing signal 220 to the contactor can be provided by another source that can respond to a fault condition (e.g., another component of the power electronics 118 or another component outside the power electronics 118). In this implementation, if failure of the VSD 206 is the cause of the fault condition, the contactor can operate independent of the VSD 206.

If an NC contactor is used, then the VSD 206 (or other source) provides an energizing signal 220 to the contactor 204 to keep the contactor switches open during normal operating conditions. A fault condition can result in the removal of the energizing signal 220 to the contactor, which results in the contactor switches closing and completing the circuit between the electrical output 160 of the turboexpander 102 and the brake resistor assembly 202.

In some embodiments, the brake resistor 202 can be disconnected from the electrical output 160 of the turboexpander 102 when operational states return to normal.

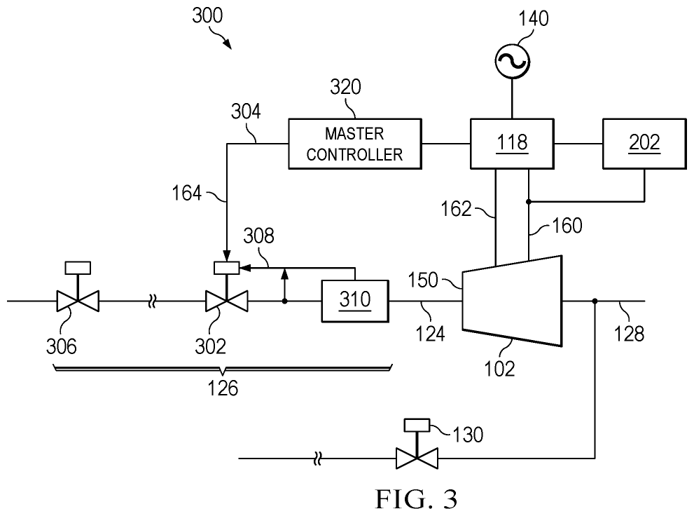

FIG. 3 is a schematic diagram of an example electric power generator system that includes a fast stop valve in accordance with embodiments of the present disclosure. Electric power generation system 300 includes a fast stop valve 302 positioned upstream of an inlet conduit 150 of a turboexpander 102. The electric power generation system 300 is similar to electric power generation system 100 described above. The electric power generation system 300 includes a turboexpander 102 that is electrically coupled to a power electronics 118 by an electrical outlet 160. The power electronics 118 can condition current output from the turboexpander 102 for delivery to a grid 140. The turboexpander 102 includes an inlet conduit 150. A process gas can flow into the turboexpander 102 through the inlet conduit 150.

A flow control system 126 can reside upstream of the inlet conduit 150. The flow control system 126 can include one or more components that can control the flow of gas into the inlet conduit 150. In embodiments, the flow control system 126 can include a fast stop valve 302. In some embodiments, the flow control system 126 can include other components, such as an isolation valve 306 and/or a pressure regulator 310.

The fast stop valve 302 is positioned within the process gas flow line proximate and upstream of the inlet conduit 150. The fast stop valve 302 is designed to close quickly to stop the flow of gas into the inlet conduit 150 during, e.g., a fault condition. The fast stop valve 302 is positioned close to the inlet conduit 150 to minimize the amount of process gas within the flow line and the turboexpander 102 after the fast stop valve 302 is closed.

The term “fast stop valve” is used herein to refer to any valve or combination of valves or combination of valves and other devices that can be used to quickly stop the flow of gas into the inlet conduit 150. One example of a fast stop valve 302 is a slam shut valve, such as an Type OSE slam shut valve. The fast stop valve 302 can be positioned upstream of the inlet conduit 150 and quickly close to prevent an overspeed event. In embodiments, the fast stop valve 302 can include a valve that is held open by latch. A diaphragm can sense gas pressure downstream of the fast stop valve 302 through an impulse line 308. In one example embodiment, as pressure through the impulse line 308 increases, the diaphragm can lift or change position. When the diaphragm reaches a certain set point (e.g., based on a threshold pressure in the impulse line), the latch can release the valve, which slams shut to stop the flow of gas into the inlet conduit 150.

The fast stop valve 302 can monitor over-pressure and/or under-pressure events downstream and can quickly close to shut off gas flow downstream of the fast stop valve 302 based on such pressure events. In some embodiments, downstream pressure changes associated with an increasing rotor speed, can cause the fast stop valve 302 to close.

In some embodiments, a pressure regulator 310 can be positioned downstream of the fast stop valve 302 and can be coupled to the fast stop valve 302 by an impulse line 308. The pressure regulator 310 can be used for both over-pressure shut of protection and under-pressure shut off protection.

In some embodiments, the fast stop valve 302 can be controlled electronically, by an electrical signal, electromagnetic signal, or wireless signal. For example, a Type OSE slam shut valve can be paired with a 3-way solenoid for remote triggering. When de-energized, the solenoid valve allows the manometric device to monitor the controlled pressure as if the solenoid valve was not present. When energized (e.g., by an electrical signal indicating a fault condition at the power grid or power electronics), the solenoid valve will be repositioned to connect the manometric device to atmospheric pressure tripping the underpressure protection slam-shut setting. Other types of operational actuators can be used to electrically control (e.g., close) the fast stop valve 302. The general purpose of the fast stop valve is to close quickly upon the detection of a fault condition at the grid or power electronics. A fault at the grid or at the power electronics can trigger the operation of the fast stop valve 302, such that the fast stop valve 302 closes immediately or as fast as possible upon detection of the fault condition.

After the fault condition is resolved, the fast stop valve 302 can be reset and the valve held open by the latch.

Other types of fast stop valves can be used. The fast stop valve can be any type of valve that can close rapidly to stop flow of fluid.

For example, a fault condition at the power electronics 118 or grid 140 can cause an actuation command signal 304 to be sent to the fast stop valve 302 (e.g. from a master controller 320 or other device, such as a circuit breaker, fuse, or other fast-acting electrical signaling circuitry). The actuation command signal 304 can cause the fast stop valve 302 to shut and stop gas flow into the inlet conduit 150 of the turboexpander 102. The fast stop valve 302 can include circuitry to receive the actuation command signal 304. The fast stop valve 302 can then shut the valve and stop the gas flow based on the actuation command signal 304. In some embodiments, the actuation command signal can be a binary signal, such as a high or low voltage applied to the fast stop valve circuitry.

In some embodiments, the fast stop valve 302 can include an electromagnetic component that keeps the fast stop valve 302 open during normal operation based on the presence of absence of current or other signal from, e.g., power electronics 118. The electromagnetic component can cause the valve to shut based on the absence (or presence) of a current or other signal from the power electronics or other source. Put differently, during a fault condition, an electromagnetic component that keeps the valve open can be toggled quickly to shut the valve.

In some embodiments, the fast stop valve 302 can receive a wireless signal from, e.g., power electronics 118 to shut the valve. The fast shut off valve 302 can include a wireless receiver (or transceiver) to receive wireless actuation command signal from, e.g., power electronics 118. The wireless actuation command signal can cause the fast shut off valve to close.

The actuation command signal 304 can originate from the power electronics 118. For example, the variable speed drive or other similar electronics can detect the fault condition and initiate the actuation command signal 304. In some cases, the actuation command signal 304 can originate from the MBC 212. The MBC 212 can include electronics that receives information from sensors that pertain to the speed of the rotor 108. If the MBC 212 determines that the speed of rotation of the rotor 108 is too high or the acceleration of the rotation of the rotor is too high, the MBC 212 can initiate the actuation command signal 304 to shut the fast stop valve 302 and stop flow of the gas into the turbine 104.

In embodiments, the pressure regulator valve 130 would be controlled to compensate for the loss of the turboexpander for pressure let-down. The pressure regulator valve 130 can, e.g., let down the pressure so that gas can continue flowing to a next stage in the PLD station. In some embodiments, an isolation valve 306 can reside upstream of the fast stop valve 302. Isolation valve 306 can isolate the turboexpander from the gas flow entirely, and direct gas to flow through the pressure regulator valve 130. The isolation valve 306 can be closed to ensure that no gas is flowing through the flow control system (including the fast stop valve) during the fault condition. The isolation will allow the electric generator system to entirely power down for safety purposes.

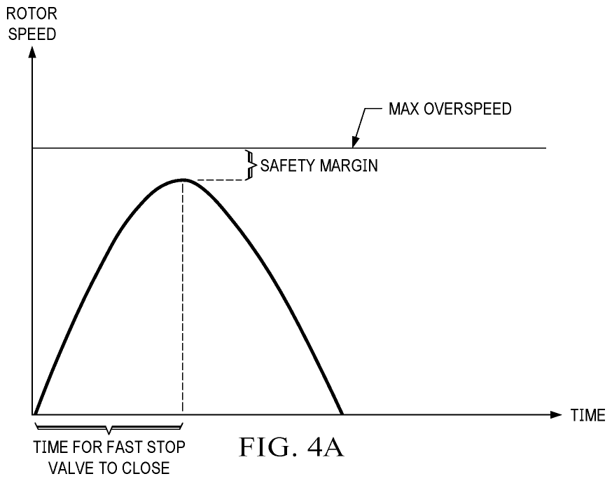

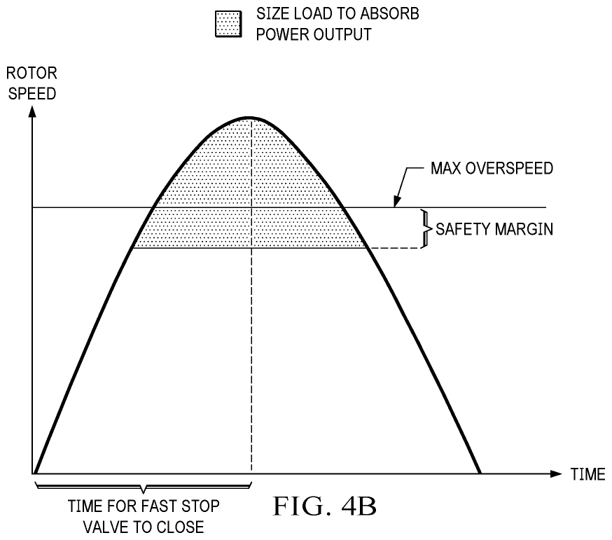

FIG. 4A is a graphical representation of a rotor speed as a function of time when using a fast stop valve to stop gas flow into an inlet conduit of a turboexpander in accordance with embodiments of the present disclosure. In FIG. 4A, at a time t=0, the fast stop valve can be triggered or caused to close. This can be due to the receipt of an actuation command signal or the presence or absence of an energizing signal or other condition, such as an over-pressure or under-pressure condition of the gas downstream of the fast stop valve. FIG. 4A shows that the fast stop valve can close and slow and stop the rotation of the rotor before the speed of the rotor breaches a safety margin or reaches maximum overspeed. After the fast stop valve is closed, and the gas is no longer flowing into the inlet conduit, the rotor will slow to a stop after some time.

FIG. 4B is a graphical representation of a rotor speed as a function of time when using a fast stop valve to stop gas flow into an inlet conduit of a turboexpander and a brake resistor in accordance with embodiments of the present disclosure. In some situations, the fast stop valve might not close fast enough to prevent an overspeed. If the valve does not close before the rotor reaches the maximum overspeed design limit, then an artificial load (such as a brake resistor assembly) can be used to further slow the rotation of the rotor. The brake resistor assembly can include circuit elements that are sized to absorb the amount of power from the turboexpander to prevent the rotor from exceeding the maximum overspeed design limit, with some safety margin. The brake resistor assembly can be impedance matched with the turboexpander. This load is proportional to the rotor's inertia, as well as the power output from the turboexpander.

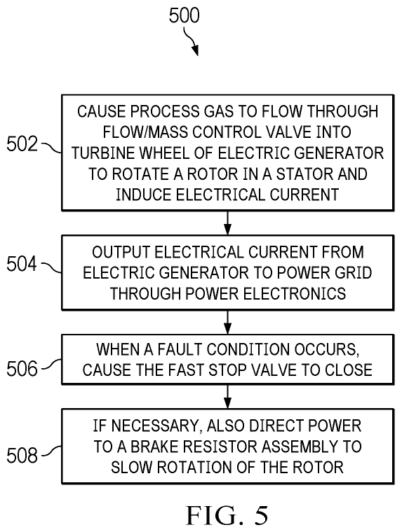

FIG. 5 is a process flow diagram for controlling a rotational speed of a rotor during a pressure letdowns sequence in accordance with embodiments of the present disclosure. During a fault condition, the heated high pressure gas supplied to the turboexpander should be turned off to prevent the turboexpander from continuing to operate. A shutdown sequence can be followed during a fault condition to prevent damaging the turboexpander components, including the rotor, as well as protecting electronic equipment. For example, during a fault condition where the braking torque to the rotor is lost, the rotor can experience overspeed from the process gas rotating the turbine wheel. To prevent rotor overspeed during a fault condition, a contactor can connect the turboexpander to a brake resistor assembly. The brake resistor assembly will prevent the rotor of the turboexpander from overspeed by acting as a load on the turboexpander and providing braking torque to the rotor. Controlling the speed of the rotor using a brake resistor assembly allows for the time it takes to close the flow control valve (or mass control valve or emergency shut-off valve) on the inlet side of the turboexpander.

At the outset, under normal operating conditions, at a pressure letdown station for example, a flow control valve residing at an inlet side of a turboexpander is open to allow heated high pressure process gas to flow into the turboexpander. The heated high pressure process gas enters an inlet of a turbine wheel, which causes the turbine wheel to spin and the heated high pressure process gas to expand and exit the turbine wheel outlet. Rotation of the turbine wheel rotates a rotor. The rotor can include a plurality of permanent magnets. Rotation of the rotor within a stator induces a current to flow in stator coils. In some embodiments, the output of the turboexpander is a three-phase alternating current. The expanded process gas is directed to a turboexpander outlet where it can continue on to other points in the pressure letdown station. (502)

The three-phase alternating current is directed to a power electronics. The power electronics can include a variable speed drive (VSD). The VSD can include a rectifier circuit to convert the three-phase alternating current into a direct current. The direct current can be directed to an inverter circuit that converts the direct current into an alternating current with an amplitude and frequency suitable for supplying the alternating current to a power grid. The VSD can supply the alternating current to the power grid. (504)

When a fault condition occurs, a flow control system can respond by stopping flow of gas into the turboexpander. The closure of the flow control system (e.g., fast stop valve or slam shut valve etc.) stops gas flow into the inlet conduit of the turboexpander. (506) In some embodiments, the fast stop valve can be closed based on a pressure change in the process gas downstream of the fast stop valve. Such a pressure change can be sensed by a diaphragm in the fast stop valve that receives pressurized process gas through an impulse line downstream of the fast stop valve. Present pressure conditions can cause the fast stop valve to release a latched valve, that slams shut and stops process gas from flowing past the fast stop valve and into the inlet conduit of the turboexpander.

The fault condition can also cause power from the generator will be directed to a brake resistor assembly by a contactor circuit. The brake resistor assembly is sized to limit the acceleration of the rotor. A contactor can connect the brake resistor assembly directly to the output of the generator. The contactor can be a normally open or normally closed contactor. An energizing signal sent to (or removed from) the contactor can cause the contactor to connect the (three-phase) electrical output of the turboexpander to the brake resistor assembly. (508)

The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

In the foregoing specification, a detailed description has been given with reference to specific exemplary embodiments. It will, however, be evident that various modifications and changes may be made thereto without departing from the broader spirit and scope of the disclosure as set forth in the claims.

What is claimed is:

1. An apparatus comprising:
an electric generator comprising:
a turbine wheel configured to receive process gas through an inlet conduit and rotate in response to expansion of the process gas flowing into an inlet of the turbine wheel and out of the outlet of the turbine wheel,
a rotor coupled to the turbine wheel and configured to rotate with the turbine wheel, and
a stationary stator, the electric generator to generate an alternating current upon rotation of the rotor within the stator;
a power electronics system electrically connected to an electrical output of the electric generator and to receive alternating current from the electric generator, the power electronics comprising circuitry to sense a fault condition; and
a flow control system residing proximate the inlet conduit and responsive to the fault condition to close a valve to stop process gas flow into the inlet conduit.

2. The apparatus of claim 1, wherein the flow control system is responsive to a pressure change to close the valve and stop process gas flow into the inlet conduit.

3. The apparatus of claim 1, wherein the flow control system comprises a slam shut valve.

4. The apparatus of claim 3, wherein the slam shut valve is configured to close based on an over-pressure or under-pressure condition of the process gas downstream of the flow control system.

5. The apparatus of claim 3, further comprising an impulse line positioned downstream of the slam shut valve and coupled to the slam shut valve, the slam shut valve to close based on pressure in the impulse line.

6. The apparatus of claim 1, wherein the flow control system closes the valve in response to a presence or absence of an energizing signal, the energizing signal indicating the fault condition.

7. The apparatus of claim 2, wherein the energizing signal originates from the power electronics system.

8. The apparatus of claim 1, the electric generator comprising:
magnetic bearing controller (MBC); and
a sensor coupled to the MBC and residing proximate the rotor to sense a speed of the rotation of the rotor; and wherein:
the magnetic bearing controller comprises circuitry to determine that the speed of the rotation of the rotor is exceeding a threshold value; and
based on the speed of the rotation of the rotor exceeding a threshold value, causing the flow control system to close the valve.

9. The apparatus of claim 1, wherein the flow control system comprises a wireless receiver to receive a wireless signal indicating that the flow control system should close the valve.

10. The apparatus of claim 1, wherein the power electronics comprises a variable speed drive connected to the electrical output of the electric generator, the variable speed drive to convert the alternating current received from the electric generator into an alternating current compatible with a power grid.

11. The apparatus of claim 10, wherein the variable speed drive comprises:
a rectifier to receive alternating current from the electric generator and convert the alternating current into direct current; and
an inverter to receive direct current from the rectifier and convert the direct current into an alternating current comprising an amplitude and frequency compatible with the power grid.

12. The apparatus of claim 1, wherein the electric generator comprises a three-phase permanent magnet synchronous generator.

13. A method comprising:
causing gas to flow through a turbine wheel of an electric generator residing downstream of a flow control valve;
generating electrical current by the electric generator;
directing electrical current generated by the electric generator to a power electronics;
detecting a fault condition; and
closing a fast stop valve to restrict gas flow to the turbine wheel based on detecting the fault condition.

14. The method of claim 13, comprising detecting a change in gas pressure downstream of the fast stop valve and closing the fast stop valve based on the detection of the change in gas pressure.

15. The method of claim 14, comprising providing pressurized process gas to the fast stop valve through an impulse line downstream of the fast stop valve, wherein detecting a change in gas pressure downstream of the fast stop valve comprises detecting a change in pressure through the impulse line.

16. The method of claim 13, comprising:
directing an energizing signal to the fast stop valve; and
causing the fast stop valve to close based on the energizing signal.

17. The method of claim 13, directing power to a brake resistor assembly after closing the fast stop valve.

18. A system comprising:
a fast stop valve to control a flow of a process gas;
an electric generator comprising:
a process gas inlet on a downstream side of the fast stop valve to receive process gas into the electric generator;
a turbine wheel configured to receive process gas and rotate in response to expansion of the process gas flowing into an inlet of the turbine wheel and out of the outlet of the turbine wheel,
a rotor coupled to the turbine wheel and configured to rotate with the turbine wheel,
a stationary stator, the electric generator to generate an alternating current upon rotation of the rotor within the stator, and
a process gas outlet to direct the process gas into a pressure letdown station; and
a power electronics system electrically connected to an electrical output of the electric generator and to receive alternating current from the electric generator, the power electronics system to connect the alternating current from the electric generator to a power grid;
wherein the fast stop valve resides proximate the process gas inlet and is configured to close upon the detection of a fault condition.

19. The system of claim 18, wherein the fast stop valve comprises a slam shut valve.

20. The system of claim 18, wherein the slam shut valve is configured to close based on an over-pressure or under-pressure condition of the process gas downstream of the flow control system.
